(19) United States
(12) Patent Application Publication
(10) Pub. No.: US 2005/0020328 A1
(43) Pub. Date: Jan. 27, 2005

(54) Spin formed transition section

(76) Inventor: Charles D Linder, Flora, IL (US)

Correspondence Address: CNH AMERICA LLC, INTELLECTUAL PROPERTY LAW DEPARTMENT, 700 STATE STREET, RACINE, WI, 53404, US

(21) Appl. No.: 10/623,924

(22) Filed: Jul. 21, 2003

(51) Int. Cl. A01F 12/00

(52) U.S. Cl. 460/68

(57) ABSTRACT

A transition section for a forward end of a threshing region of an agricultural combine, for receiving crop material feed into the threshing region, the transition section being made from a single spin formed metal sheet.

### TECHNICAL FIELD

This invention relates generally to a transition section or cone for the forward end of a threshing section or region of an agricultural combine, and more particularly, to a transition section spin formed from a unitary, continuous sheet of metal.

### BACKGROUND ART

Generally, in an axial flow combine, crop material is fed to the forward inlet end of the threshing section or region of the combine from a generally rectangular feeder house. The forward end of the threshing region has a cylindrical shape, and a transition from the rectangular shape of the feeder house to the cylindrical shape of the threshing region must be made. It is well known to provide a transition section for this purpose having a frusto-conical shape inner surface. Reference in this regard, Drayer U.S. Pat. No. 3,827,443, issued Aug. 6, 1974 to International Harvester Company; and McMillen et al. U.S. Pat. No. 4,148,323, issued Apr. 10, 1979 to International Harvester Company. In the past, such transition sections have been constructed out of complicated weldments using unusual geometry. This has made these parts expensive to produce and difficult to control dimensionally and shape wise. For improved wearability, the parts have been heat treated, which has been found to increase dimensional and shape distortions.

The threshing section or region contains a rotating rotor having a forward inlet end which rotates within the transition section and includes helical flights for picking up and rotatably impelling crop material from the transition section to the threshing section or region, and it is desirable for good operation that the inner surface of the transition section be maintained at a set distance from such flights. One problem observed when using the past weldments as noted above is distortion and warpage thereof, which can vary this spacing.

Thus, what is sought is a transition section for the forward inlet end of the threshing section or region of an agricultural combine that is simpler to manufacture than a weldment, can be produced from a single sheet of material, without seams on an inner surface thereof, and which has reduced resultant distortion, warpage and other problems.

### SUMMARY OF THE INVENTION

What is disclosed is a transition section for an inlet or forward end of a threshing section or region of an agricultural combine, for receiving crop material fed into the threshing section or region from the feeder house of the combine, the transition section including a metal sheet spin formed so as to have a substantially uniformly round preferably frusto-conical shape inner surface portion extending convergingly from the feeder house toward the forward end of the threshing region. The transition section can additionally include a lip, rim or flange around one or both ends for mounting purposes or the like, which can be integrally spin formed with the transition section.

An advantage of the present transition section is a lower cost of manufacture compared to a weldment. Another advantage is that as a result of spin forming from a single or unitary sheet of metal the residual stresses in the spin formed frusto-conical part are more symmetrical, such that the part is less likely to deform, distort or warp, and the spaced relation to the rotor flights can be better and more uniformly maintained. Spin forming also allows use of better metals, particularly steels, which have improved wear characteristics compared to weldments, due to work hardening. This reduces the need for additional heat treating. The better wear characteristics also allow usage of thinner gauge metal, which reduces weight compared to weldments.

### BRIEF DESCRIPTION OF THE DRAWINGS

FIG. 1 is a fragmentary side elevational view of a representative axial flow agricultural combine including a transition section according to the present invention;

FIG. 2 is a fragmentary perspective representation of feeder apparatus and a forward inlet end of a threshing region of the combine of FIG. 1, showing the present transition section extending around an inlet end of a rotor of the threshing region;

FIG. 3 is a front view of the threshing section and inlet end of the rotor, and showing in phantom a profile of the feeder apparatus;

FIG. 4 is a sectional representation of a transition section of the invention being formed by spin forming apparatus;

FIG. 5 is a front view of a transition section; and

FIG. 6 is a side view of a transition section.

### DETAILED DESCRIPTION OF THE INVENTION

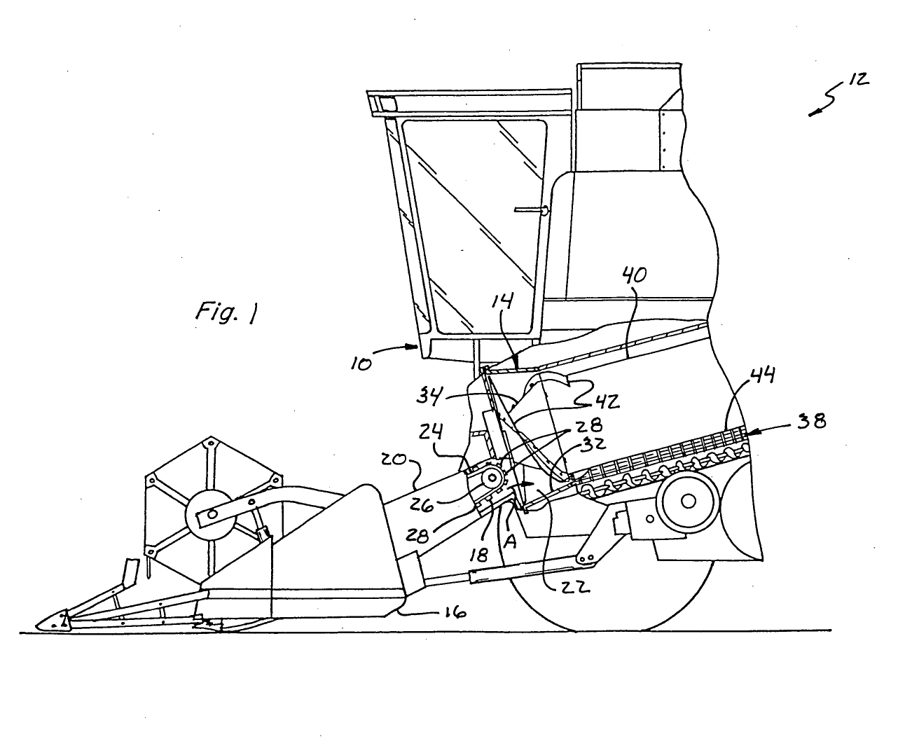

Referring now to the drawings, in FIG. 1, a forward end 10 of a representative axial flow agricultural combine 12 is shown, including a transition section 14 constructed and operable according to the teachings of the present invention. Forward end 10 of combine 12 generally includes a header 16 for severing crop material (not shown) from plants in an agricultural field, and gathering the crop material for conveyance by feeder apparatus 18 through a feeder house 20 into a lower region 22 of transition section 14, as generally denoted by arrow A.

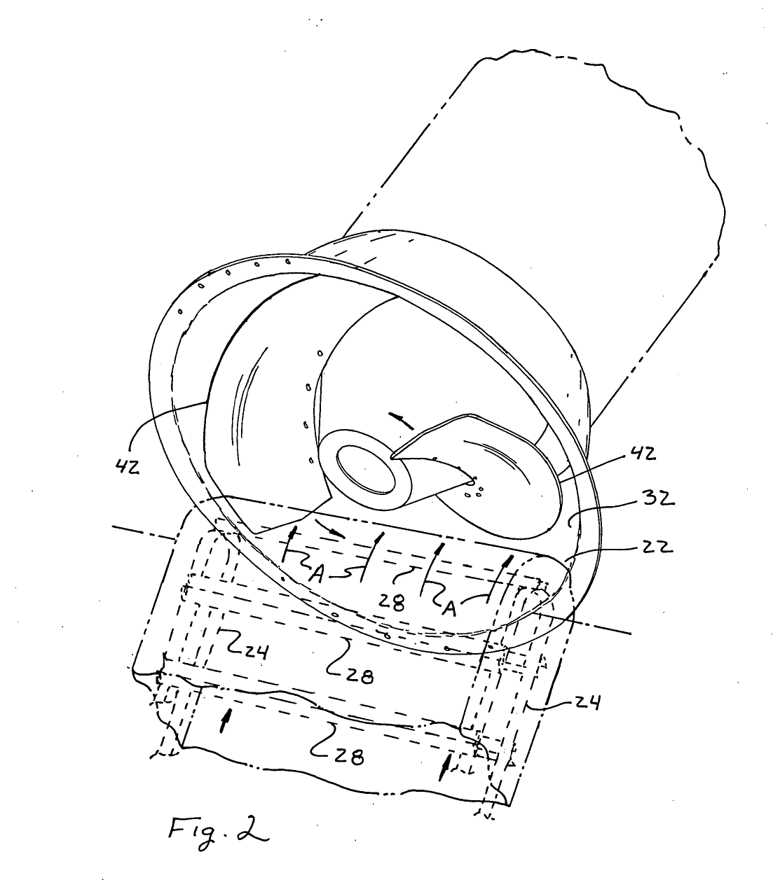

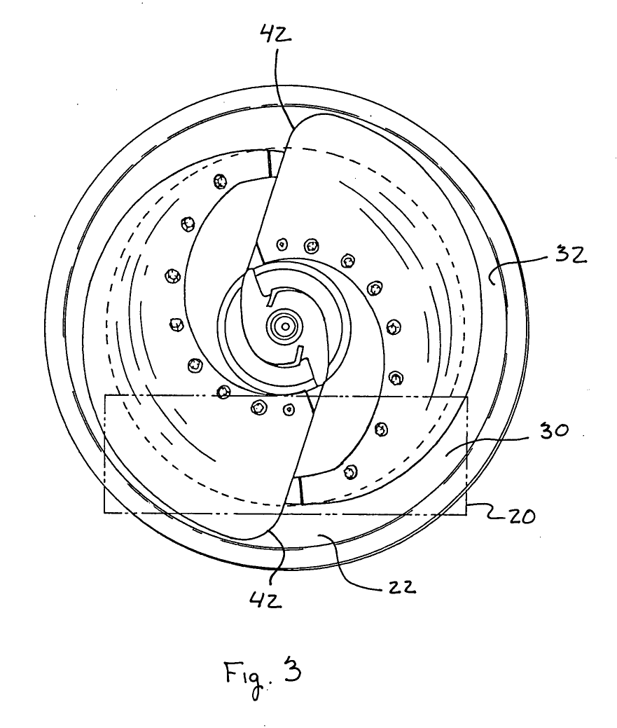

Referring also to FIGS. 2 and 3, feeder apparatus 18 generally includes several parallel, endless chains 24 which encircle sprockets or a drum (not shown) located in feeder house 20 adjacent to header 16, and sprockets 26 adjacent to transition section 14. Slats 28 extend between and are supported by chains 24 and move with chains 24 in a rearward direction along a lower surface of feeder house 20, for feeding the crop material into lower region 22 of transition section 14, as illustrated by the additional arrows A in FIG. 2. Here, in reference to FIG. 3, it should be noted that feeder house 20 has an elongate, rectangular profile shape when viewed from the forward or rearward end and includes a correspondingly elongate, rectangular shape rear discharge opening 30 for the flow of the crop material into lower region 22 of transition section 14.

Transition section 14 is shown having a preferred substantially frusto-conical shape inner surface portion 32 extending around a forward inlet end 34 of a rotatable rotor 36 of threshing apparatus 38 of combine 12 in coaxial relation thereto. Inner surface portion 32 extends convergingly in the rearward direction from feeder house 20 toward a cylindrical threshing section 40 of rotor 36. Forward inlet end 34 of rotor 36 preferably has an oppositely oriented frusto-conical shape, that is, extending divergingly rearwardly toward threshing section 40. Forward inlet end 34 of rotor 36 includes a pair of helical flights 42 extending from a forwardmost end thereof, rearwardly toward cylindrical threshing section 40. Rotor 36 is rotatable about a longitudinal axis thereof in coaxial relation to inner surface portion 32 such that flights 42 will impel crop material along inner surface portion 32 from lower region 22 to cylindrical threshing section 40 which has bars or other elements thereon that in cooperation with a cylindrical concave 44 will thresh grain from the crop material. The grain and other smaller pieces of the crop material will then pass through apertures in concave 44 to a cleaning system of the combine (not shown) which will separate the grain from the other material, all in the well known manner. In this regard, for efficient threshing action and operation, it is desirable for the crop material to be picked up by flights 42 and flow smoothly rearwardly therealong in a spiral path around inner surface portion 32 into threshing section 40. Thus, it is desirable that the crop material, which can include stalks, long leaves, branches, and weed vines and the like, not become caught between the edges of the flights and surface portion 32 in such a manner so as to significantly impede flow therealong nor become entangled or wrapped around the rotor so as to impede its rotation or clog and reduce the infeeding of the crop material into the threshing region. It may also be desirable that the space between the edges of the flights be substantially uniform to lessen the possible occurrence of material entering the space at one location around the rotational axis then being pinched or wedged at other locations such as to possibly effect a braking action on the rotation of rotor 36 or impede material flow along the flights to the threshing section.

A substantially round unitary or one piece transition section 14 having no seams on inner surface portion 32 has been found to provide the desirable operational properties set forth above. Uniform roundness and close tolerance to nominal diameter sizes are achieved by spin forming section 14. Spin formed sections 14 have also been found not to have the asymmetrical stresses present in weldments from non-uniform heating and weld seams that can result in deformation and distortion such as out-of-roundness. Additionally, as a result of being spin formed from a unitary sheet of metal such as steel, inner surface portion 32 of section 14 can have a desirable grain flow pattern which can be oriented to provide improved wearability compared to the previously used weldments. Because of the improved wearability, and the lesser distorting stresses imparted into the transition section by the spin forming process, it has been found that additional heat treating is not required and the sectional thickness of section 14 can be reduced compared to the previously used weldments. Better roundness allows transition section 14 to be closely coaxial with rotor 36, as desired or required, for better material flow.

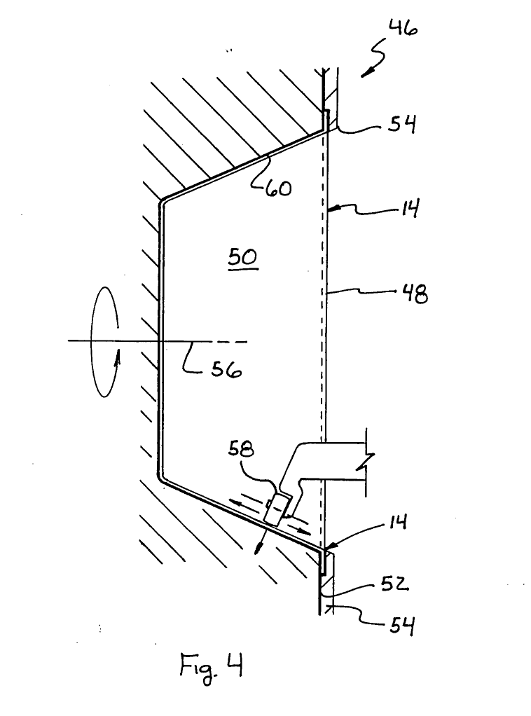

Referring also to FIG. 4, a transition section 14 is shown being spin formed by representative spin forming apparatus 46 which is simplified for clarity. Essentially, in a spin forming process, a unitary piece of sheet metal represented by sheet 48 is secured over a cavity 50 of a spin forming mandrel 52 using suitable holding elements 54 such as clamps, a holding ring, or the like. Mandrel 52 is then rotated about an axis 56 through cavity 50 while a roller 58 is rolled repeatedly against sheet 48 under pressure to conform it to an interior surface 60 of the mandrel in the well known manner, as illustrated by the arrows. Several progressively deeper mandrels can be used for the spin forming process for forming a relatively deep or large cone or bowl shape transition section from a single sheet. Mandrel 52 can be rotated in a direction opposite that of the rotation of rotor 36 to provide good grain direction in the metal for improved wearability as noted above. As a result of the rolling of roller 58 under pressure against the surface of sheet 48 and the underlying mandrel, the surface of the sheet is hardened as it is conformed to the mandrel which also has been found to improve wearability. As a result of the symmetry about axis 56, residual stresses in the finished transition section 14 imparted by the spin forming process are also largely symmetrical such that less stress deformation and distortion can be expected.

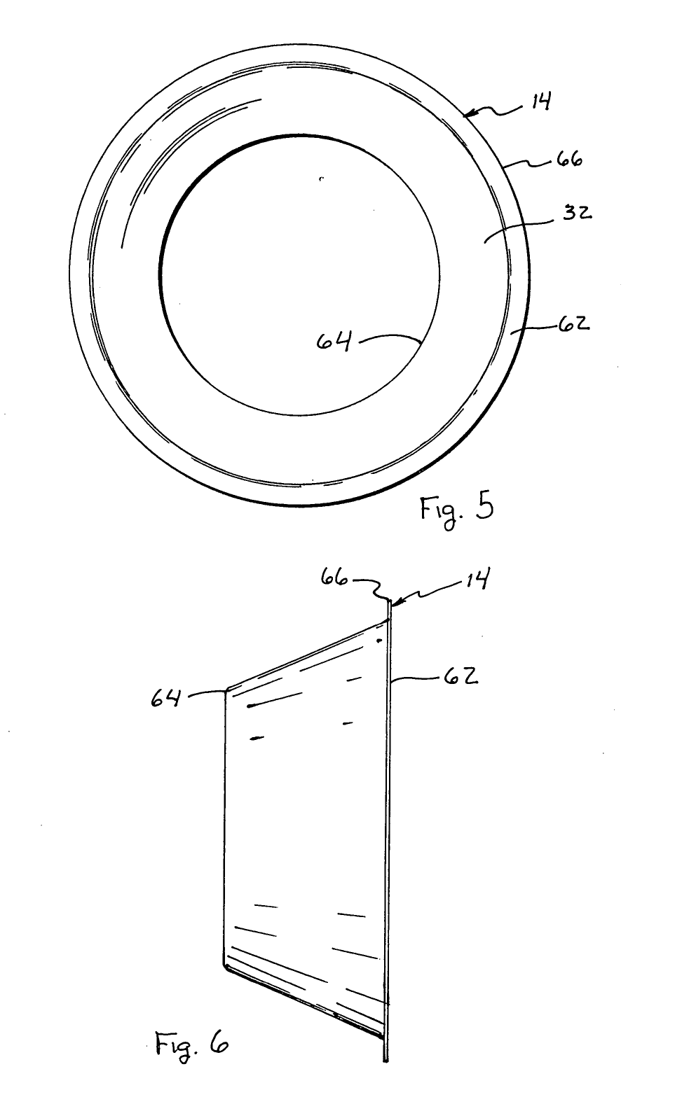

Referring also to FIGS. 5 and 6, a preferred transition section 14 has a frusto-conical shape inner surface portion 32 which extends convergingly from a larger diameter forward or inlet end portion 62 to be positioned adjacent to feeder house 20 (FIG. 1) and a smaller diameter rear end portion 64 to be positioned adjacent to a forward end of threshing section 40. Both end portions 62 and 64 include an opening therethrough. End portion 62 optionally includes a radially outwardly extending lip or rim 66 therearound for mounting or other purposes. The slope of inner surface portion 32 will preferably closely match the slope of the outer edges of flights 42 of rotor 36, such that with the roundness of transition section 14, desired spacing can be maintained between the flights and surface portion 32, as desired or required.

It should be noted that although inner surface portion 32 of spin formed transition section 14 is shown here having a uniformly sloped frusto-conical profile shape, it could alternatively have more than one sloped portion and/or one or more portions having a curved or bowl or cylindrical shape, as desired.

Dimensionally, end portion 62 of transition section 14 preferably has a closely toleranced diametrical extent of 1197 millimeters and section 14 has an overall axial length of 464 millimeters. The sectional thickness is a minimum of 4 millimeters. The preferred slope angle is 66.64 degrees. These dimensions are representative of a wide variety that can be employed.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. A transition section for a forward end of a threshing region of an agricultural combine, for receiving crop material fed into the threshing region, comprising:
a unitary metal sheet spin formed so as to have a smooth, seamless and hardened frusto-conical shape inner surface portion extending convergingly toward the forward end of the threshing region.

2. (cancelled).

3. The transition section of claim 1 further comprising an outwardly extending annular lip around a larger forward end of the transition section.

4. The transition section of claim 1 wherein the metal sheet has a thickness of at least about 4 millimeters.

5. An agricultural combine, comprising in combination, an elongate generally cylindrical rotor casing defining a forward threshing region, the forward threshing region being provided with a frusto-conical shape transition section for endwise reception of crop material, and a rotor disposed within said casing in substantially coaxial relationship and substantially coextensive therewith for rotation therein, the transition section being seamless and hardened by being spin formed from a unitary metal sheet.

6. (cancelled).

7. The agricultural combine of claim 5 including an integrally formed radially outwardly extending rim around a forward end thereof.

8. A transition section for a forward end of a threshing section of an agricultural combine, for receiving crop material fed into the threshing section, the transition section being formed by a process comprising a step of spin forming a single metal sheet so as to have a seamless and hardened frusto-conical shape inner surface portion.

9. (cancelled).
